(19) United States
(12) Patent Application Publication
(10) Pub. No.: US 2014/0167398 A1
(43) Pub. Date: Jun. 19, 2014

(54) Lawn Care Vehicle Adjustable Steering Assembly

(71) Applicants: Duncan Burns, Charlotte, NC (US); Brad Graham, Summerville, SC (US); Juan Rodriguez, Lexington, SC (US); Steve Brinkman, Martinez, GA (US)

(72) Inventors: Duncan Burns, Charlotte, NC (US); Brad Graham, Summerville, SC (US); Juan Rodriguez, Lexington, SC (US); Steve Brinkman, Martinez, GA (US)

(73) Assignee: Husqvarna Consumer Outdoor Products, N.A., Inc., Charlotte, NC (US)

(21) Appl. No.: 14/127,324

(22) PCT Filed: Jun. 29, 2011
(86) PCT No.: PCT/US11/42264

§ 371 Date: Feb. 28, 2014

(51) Int. Cl. A01D 34/82; B62D 1/185; B62D 1/183; A01D 34/64

(52) U.S. Cl. CPC A01D 34/82; A01D 34/64; B62D 1/185; B62D 1/183
USPC 280/775

(57) ABSTRACT

A riding lawn care vehicle may include a frame and a steering assembly. Wheels of the riding lawn care vehicle may be attachable to the frame. The steering assembly may be operably coupled to the frame and configured for steering at least one wheel of the riding lawn care vehicle. The steering assembly may include a vertical adjustment assembly and a folding assembly. The vertical adjustment assembly may be configured to enable telescopic adjustment a height of handles associated with the steering assembly. The folding assembly may be configured to enable folding of at least a portion of the steering assembly.

### TECHNICAL FIELD

Example embodiments generally relate to lawn care vehicles and, more particularly, relate to an adjustable steering assembly for vehicles configured for performing lawn maintenance.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines (e.g., less than 200 cubic centimeters (cc)) and are relatively inexpensive. Meanwhile, at the other end of the spectrum, riding lawn mowers, such as lawn tractors, can be quite large and sometimes have engines exceeding 400 cc. Riding lawn mowers can sometimes also be configured with various functional accessories (e.g., trailers, tillers and/or the like) in addition to grass cutting components. Riding lawn mowers provide the convenience of a riding vehicle as well as a typically larger cutting deck as compared to a walk-behind model.

By their very nature, riding lawn mowers include steering assemblies that are used to direct the movement of the riding lawn mowers. The steering assemblies often take the familiar form of a steering wheel. However, handlebar assemblies have also been used in some cases. More recently, some zero turn mowers have employed separate steering levers or even a joystick to provide steering functionality. There are clearly a number of steering assembly options from which to choose when an operator considers purchasing a riding lawn mower. However, once a choice is made with respect to a particular machine and its respective steering assembly, adjustment options may be somewhat limited.

### BRIEF SUMMARY OF SOME EXAMPLES

Accordingly, in order to improve operator comfort, some example embodiments may provide an adjustable steering assembly for use on a lawn care vehicle. Such an adjustable steering assembly may enable operators to make steering assembly adjustments to positively impact user experience in relation to comfort and ease of operation when utilizing a lawn care vehicle employing, for example, a T-bar steering handle. Moreover, in some cases, the adjustable steering assembly may enable the lawn care vehicle to take up less space and/or subject the steering assembly to less risk of abnormal stress when the lawn care vehicle is being stored or shipped by reducing the overall lawn care vehicle profile.

In one example embodiment, a riding lawn care vehicle is provided. The riding lawn care may include a frame and a steering assembly. Wheels of the riding lawn care vehicle may be attachable to the frame. The steering assembly may be operably coupled to the frame and configured for steering at least one wheel of the riding lawn care vehicle. The steering assembly may include a vertical adjustment assembly and a folding assembly. The vertical adjustment assembly may be configured to enable telescopic adjustment of a height of handles associated with the steering assembly. The folding assembly may be configured to enable folding of at least a portion of the steering assembly.

In another example embodiment, an adjustable steering assembly for employment on a riding lawn care vehicle is provided. The adjustable steering assembly may include a vertical adjustment assembly and a folding assembly. The vertical adjustment assembly may be configured to enable telescopic adjustment a height of handles associated with the adjustable steering assembly relative to a rotatable, but vertically fixed portion of the adjustable steering assembly that is operably coupled to at least one wheel of the riding lawn care vehicle. The folding assembly may be configured to enable folding of at least a portion of the adjustable steering assembly.

Some example embodiments may improve an operator's ability to manipulate the position of the steering assembly of a lawn care vehicle. The user experience associated with achieving a comfortable ride on a riding lawn care vehicle may therefore be improved.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a riding lawn care vehicle having an adjustable steering assembly according to an example embodiment;

FIG. 2 illustrates a perspective view of the steering assembly in a fixed state in which a height of a T-bar steering handle has been set according to an example embodiment;

FIG. 3 illustrates a perspective view of the steering assembly in an adjustable state in which the height of the T-bar steering handle may be adjusted according to an example embodiment;

FIG. 4 illustrates a perspective view of the steering assembly after being folded by employing the folding assembly according to an example embodiment; and

FIG. 5 illustrates a more detailed view of the folding assembly according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true.

Some example embodiments may improve operator comfort for operators of lawn care vehicles such as, for example, riding lawn mowers. In this regard, some example embodiments may provide an adjustable steering assembly for use on a lawn care vehicle. Such an adjustable steering assembly may enable operators to make steering assembly adjustments in relation to the height of the steering assembly. In some embodiments, the steering assembly may be provided in the form of a T-bar steering handle with a telescoping or collapsible steering shaft. The T-bar steering handle may be adjusted to a height that is comfortable for the user. Furthermore, in some example embodiments, the T-bar steering handle may collapse or extend to provide a telescoping action for height adjustment, while also including a folding apparatus to enable the T-bar steering handle to be folded down to reduce a profile of the lawn care vehicle. By providing options for reduction of the overall lawn care vehicle profile, the lawn care vehicle may be shipped with the steering assembly already installed (albeit perhaps folded) so that installation of the steering assembly is not required after unpacking a shipped model.

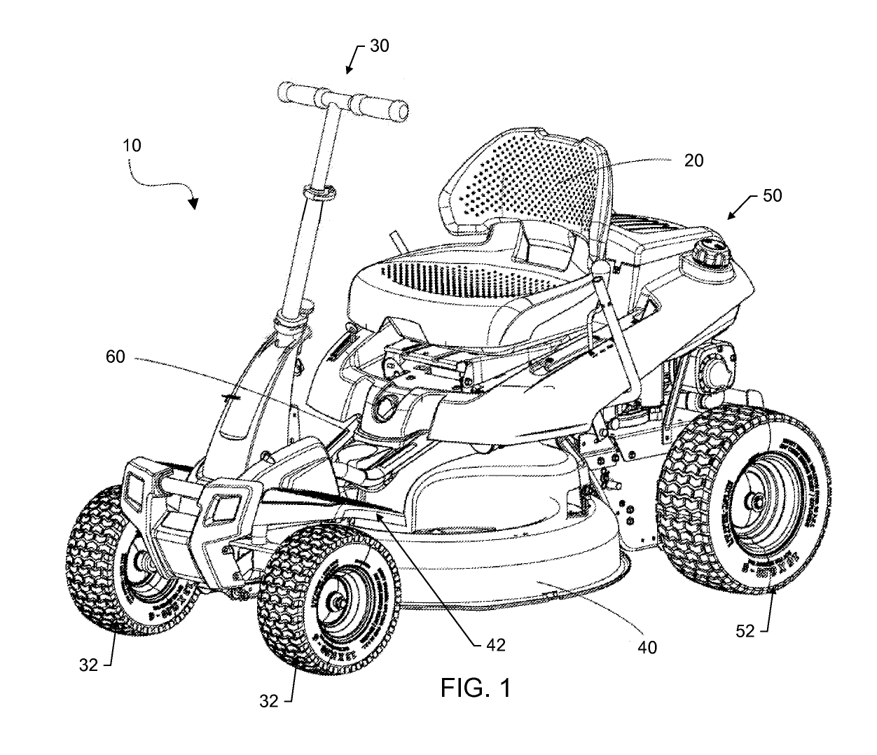

FIG. 1 illustrates a riding lawn care vehicle having an adjustable steering assembly according to an example embodiment. In some embodiments, the riding lawn care vehicle 10 may include seat 20 that may be disposed at a center, rear or front portion of the riding lawn care vehicle 10. The riding lawn care vehicle 10 may also include a steering assembly 30 (e.g., a steering wheel, handle bars, or the like) functionally connected to front wheels 32 (or rear wheels in other embodiments) of the riding lawn care vehicle 10 to allow the operator to steer the riding lawn care vehicle 10. The operator may sit on the seat 20, which may be disposed to the rear of the steering assembly 30 to provide input for steering of the riding lawn care vehicle 10 via the steering assembly 30. In an example embodiment, the steering assembly 30 may be an adjustable steering assembly including a T-bar steering handle 34, a vertical adjustment assembly 36, and a folding assembly 38. The adjustable steering assembly may provide operators with an ability to adjust the height of the T-bar steering handle 34 using the vertical adjustment assembly 36, or fold the T-bar steering handle 34 using the folding assembly 38 in order to decrease the profile of the riding lawn care vehicle 10 for shipping and/or storage.

In some embodiments, the seat 20 includes a seat back that is vertically adjustable and/or foldable in order to further decrease the profile of the riding lawn care vehicle for shipping and/or storage. In some embodiments, the adjustable steering assembly is configured so that, for shipping and/or storage, it can be adjusted to be at the same height as or lower than the seat back when the seat back is in its lowest vertical position.

The riding lawn care vehicle 10 may also include a cutting deck 40 having at least one cutting blade mounted therein. The cutting deck 40 may be positioned behind the front wheels 32 in a position to enable the operator to cut grass using the cutting blade when the cutting blade is rotated below the cutting deck 40 when the cutting deck 40 is in a cutting position. However, in some alternative examples, the cutting deck 40 may be positioned in front of the front wheels 32. In some embodiments, a footrest 42 (e.g., one on each side of the riding lawn care vehicle 10) may also be positioned above the cutting deck 40 and/or above the front wheels 32 to enable the operator to rest his or her feet thereon while seated in the seat 20. When operating to cut grass, the grass clippings may be captured by a collection system, mulched, or expelled from the cutting deck 40 via either a side discharge or a rear discharge.

In the pictured example embodiment, an engine 50 of the riding lawn care vehicle 10 is disposed below and to the rear of a seated operator. However, in other example embodiments, the engine 50 could be in different positions such as in front of the operator. As shown in FIG. 1, the engine 50 may be operably coupled to rear wheels 52 to provide drive power for the riding lawn care vehicle 10. The engine 50, the steering assembly 30, the cutting deck 40, the seat 20 and other components of the riding lawn care vehicle 10 may be operably connected (directly or indirectly) to a frame 60 of the riding lawn care vehicle 10. The frame 60 may be a rigid structure configured to provide support, connectivity and interoperability functions for various ones of the components of the riding lawn care vehicle 10.

In some example embodiments, the steering assembly 30 may be embodied as an assembly of metallic or other rigid components that may be welded, bolted or otherwise attached to each other and coupled to the wheels (front wheels 32 in this example) of the riding lawn care vehicle 10 to which steering inputs are provided. For example, the steering assembly 30 may include or otherwise be coupled with a rack and pinion assembly to translate rotational motion applied to the steering assembly 30 into directional inputs to orient the wheels accordingly. Other steering control systems may be employed in some alternative embodiments.

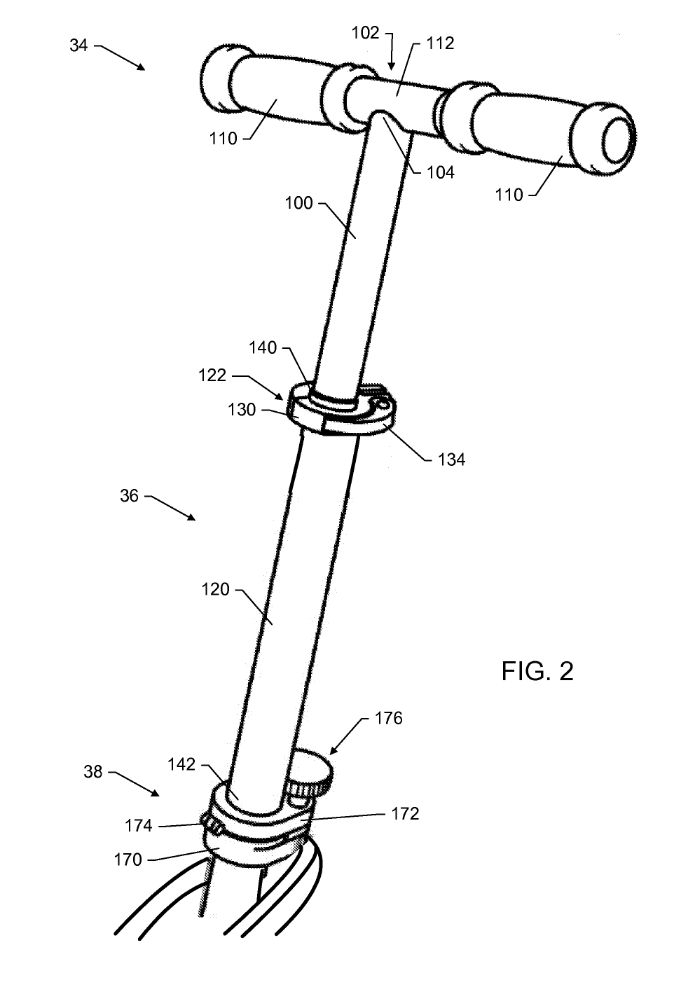

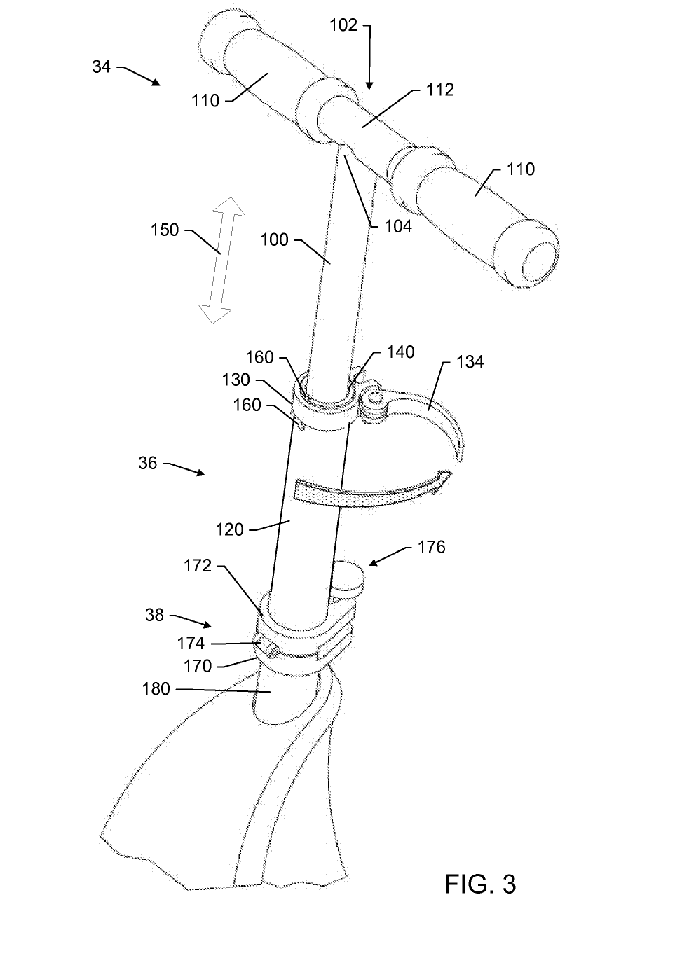

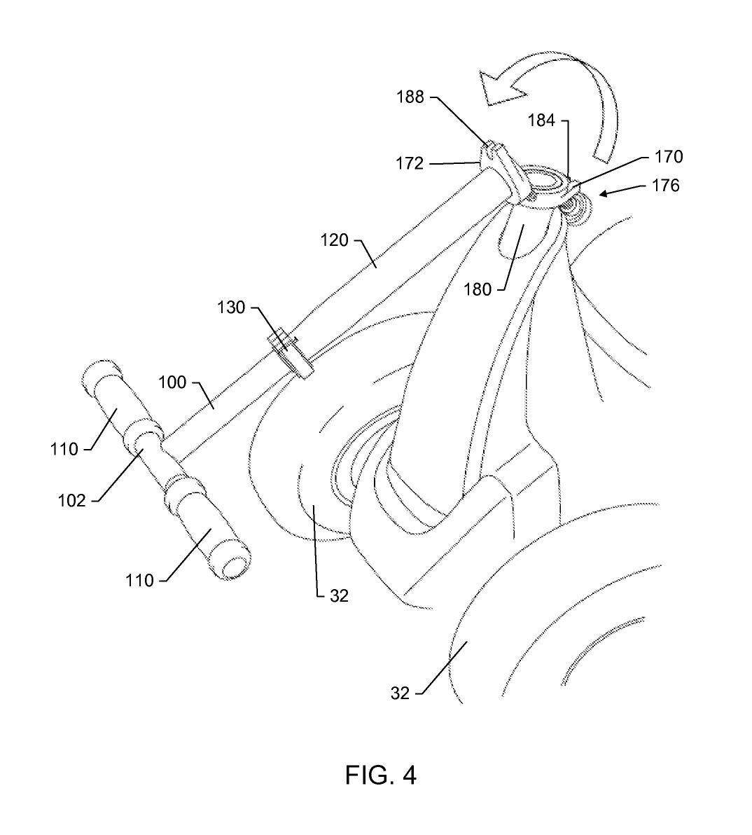

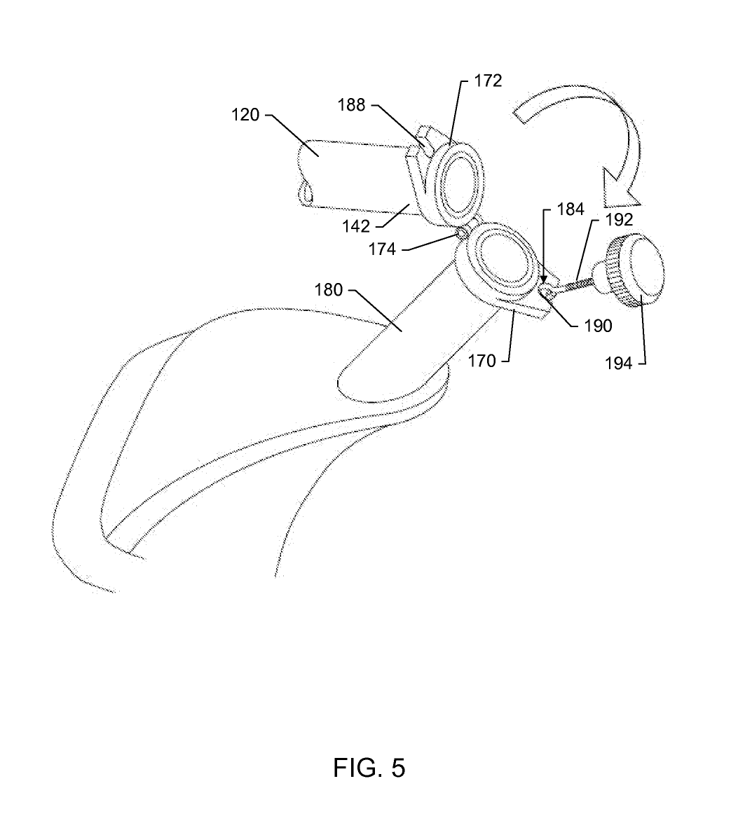

FIGS. 2-5 illustrate more detailed views of some portions of the steering assembly 30 to illustrate an example embodiment. In this regard, FIG. 2 illustrates a perspective view of the steering assembly 30 in a fixed state in which a height of the T-bar steering handle 34 has been set according to an example embodiment. FIG. 3 illustrates a perspective view of the steering assembly 30 in an adjustable state in which the height of the T-bar steering handle 34 may be adjusted according to an example embodiment. FIG. 4 illustrates a perspective view of the steering assembly 30 after being folded by employing the folding assembly 38 according to an example embodiment. FIG. 5 illustrates a more detailed view of the folding assembly 38 according to an example embodiment.

Referring now to FIGS. 2-5, the T-bar steering handle 34 of an example embodiment may include a handlebar stem 100 and a handle bar 102. The handlebar stem 100 may be a cylindrical tube or rod made of a metallic, composite or other rigid material having a first end 104 that may be connected to the handle bar 102, and a second end that may be placed in operable communication with components of the vertical adjustment assembly 36. The handle bar 102 may be a cylindrical tube or rod made of a metallic, composite or other rigid material having handles 110 positioned at each respective opposite longitudinal end of the handle bar 102. The handles 110 may include or be made of, for example, rubber, plastic, foam, or other material that may facilitate provision of a comfortable gripping surface. However, the handles 110 need not be provided in some examples and the operator may merely grip the handle bar 102 directly on opposite ends thereof

Furthermore, it should be appreciated that although the handlebar stem 100 and the handle bar 102 of an example embodiment are cylindrical and therefore have a circular cross section, other shapes may alternatively be employed in some embodiments. For example, the handlebar stem 100 and/or the handle bar 102 may be rods or tubes having a square, rectangular, oval, star, hexagonal, pentagonal, or other geometric shape. In embodiments where the handlebar stem 100 has a particular shape, it should further be appreciated that some other components to which the handlebar stem 100 connects may also have corresponding shapes.

The first end 104 of the handlebar stem 100 may be joined to a midpoint 112 between the handles 110 on the handle bar 102. As such, the handlebar stem 100 may extend substantially perpendicularly from the midpoint 112 of the handle bar 102. In some examples, the connection between the handlebar stem 100 and the handle bar 102 may be provided by welding, bolting, riveting, snap fitting, or any of a number of other suitable methods. By rigidly fixing the first end 104 of the handlebar stem 100 to the midpoint 112 between the handles 110 while the second end of the handlebar stem 100 is operably coupled to the riding lawn care vehicle 10, any force provided to one of the handles 110, or forces applied simultaneously to both handles 110 in opposing directions, may cause a rotation of the T-bar steering handle 34 via rotation of the handlebar stem 100 around an the axis of rotation that substantially passes through a longitudinal center of the handlebar stem 100. Rotation of the handlebar stem 100 may be translated to corresponding rotation of other steering assembly 30 components to ultimately enable steering of the riding lawn care vehicle 10.

The vertical adjustment assembly 36 of some example embodiments may include a stem receiver 120 and a locking assembly 122. The locking assembly 122 of one example embodiment may include a locking cam 130. The locking cam 130 may be one example of a locking device that may be employed in some example embodiments and may further include a locking lever 134. The stem receiver 120 may include a first end that may be referred to as a receiving end 140, and a second end that may be referred to as a folding end 142. The stem receiver 120 of an example embodiment may be a cylindrical tube or rod made of a metallic, composite or other rigid material. However, the shape of the stem receiver 120 may be substantially similar to the shape of the handlebar stem 120 in embodiments where other than a cylindrical shape is employed.

In an example embodiment, the second end of the handlebar stem 100 may be inserted into the receiving end 140 of the stem receiver 120 of the vertical adjustment assembly 36. The handlebar stem 100 may have an external periphery that is sized to be slightly smaller than an internal periphery of the stem receiver 120. In other words, a diameter measured between external surfaces of the handlebar stem 100 may be slightly smaller (e.g., 0.25 to 2 mm) smaller than a diameter measured between internal surfaces of the stem receiver 120. Accordingly, the handlebar stem 100 may be sized such that the handlebar stem 100 may be telescopically slid into or extended out of the stem receiver 120. When the steering assembly 30 is attached to a riding lawn care vehicle 10, it should be appreciated that extending the handlebar stem 100 out of the stem receiver 120 raises a height of the handle bar 102 and therefore also raises a height of the T-bar steering handle 34. Similarly, sliding the handlebar stem 100 into the stem receiver 120 lowers a height of the handle bar 102 and therefore also lowers a height of the T-bar steering handle 34. The bi-directional options for raising and lowering the height of the T-bar steering handle 34 are illustrated by arrow 150 in FIG. 3. After the operator adjusts the height of the T-bar steering handle 34 to a comfortable level with the locking device (e.g., the locking cam 130) unlocked, the locking device may be locked, by hand, to fix the corresponding height (e.g., via closing the locking lever 134 by clamping it to a body of the locking cam 130).

In some embodiments, the receiving end 140 of the stem receiver 120 may include one or more slots 160 that may extend inward from the receiving end 140 toward a middle portion of the stem receiver 120 a relatively short distance. The one or more slots 160 may pass entirely through the tube defining the stem receiver 120 to define flexible portions of the stem receiver 120 that may be clamped into frictional contact with the handlebar stem 100. As such, the one or more slots 160 may be provided in the receiving end 140 to enable flexibility with respect to decreasing the circumference of the receiving end 140 by applying external pressure thereto using the locking cam 130.

The locking cam 130 may be an adjustable bracket having an unlocked position in which an internal periphery of the locking cam 130 is relaxed or enlarged to enable the locking cam 130 to apply no pressure or at least a reduced amount of pressure to the receiving end 140 proximate to the one or more slots 160 to define an adjustable (or unlocked) state, and a locked position in which an internal periphery of the locking cam 130 is restricted or reduced to enable the locking cam 130 to apply pressure to the receiving end 140 to define a fixed (or locked) state. The fixed and adjustable states of the locking cam 130 may be determined based on a position of the locking lever 134. For example, when the locking lever 134 is extended away from a main body of the locking cam 130 (as shown in FIG. 3), the locking cam 130 may be in the adjustable state and allow collapsible or telescopic movement of the handlebar stem 100 up or down (as shown by arrow 150) to make height adjustments for the T-bar steering handle 34. Meanwhile, when the locking lever 134 is folded toward the main body of the locking cam 130 (as shown in FIG. 2), the locking cam 130 may be in the fixed state and prevent collapsible or telescopic movement of the handlebar stem 100 up or down thereby fixing the height of the T-bar steering handle 34.

In the adjustable state, the locking cam 130 may not reduce the circumference of the receiving end 140 sufficiently to prevent movement of the handlebar stem 100 within the stem receiver 120. However, in the fixed state, the locking cam 130 may reduce the circumference of the receiving end 140 sufficiently to prevent movement of the handlebar stem 100 within the stem receiver 120. In other words, for example, when in the fixed state, the locking cam 130 may frictionally lock the position of the handlebar stem 100 within the stem receiver 120 by clamping inwardly on the receiving end 140. Given the presence of the one or more slots 160, the receiving end 140 may be enabled to contract to frictionally engage the handlebar stem 100 to prevent movement thereof

In an example embodiment, the longitudinal length of the handlebar stem 100 may be approximately equal to the longitudinal length of the stem receiver 120. However, in some embodiments, the handlebar stem 100 may be slightly longer than the length of the stem receiver 120 so that, for a length L of the stem receiver 120, at full extension of the handlebar stem 100, approximately a length L of the handlebar stem 100 may be exposed while still providing a sufficient portion of handlebar stem 100 to be held fixed within the stem receiver 120. Accordingly, for some examples, a maximum adjustable height of the T-bar steering handle 34 may change by an amount approximately equal to the length L.

The folding assembly 38 may be provided at the folding end 142 of the stem receiver 120. The folding assembly 38 may include a fixed member 170 and a moveable member 172 that may be connected to each other by a hinge 174. The folding assembly 38 may also include a locking member 176 that may be configured to enable the moveable member 172 to be locked in proximity to the fixed member 170 or to be free to rotate away from the fixed member 170 by rotation about the hinge 174. As such, the hinge 174 may enable movement of the moveable member 172 relative to the fixed member 170 by rotation about an axis defined by the hinge 174.

The moveable member 172 may be affixed to the folding end 142 of the stem receiver 120. The fixed member 170 may be affixed to an end of a base rod 180 that may be operably connected to other steering components of the steering assembly 30 (e.g., such as a rack and pinion assembly). The base rod 180 (and the fixed member 170) may rotate about an axis of rotation defined substantially through a longitudinal center of the base rod 180, but may otherwise not move in the directions shown by arrow 150.

In an example embodiment, the fixed member 170 and the moveable member 172 may be folded together (e.g., as shown in FIGS. 1-3) and locked in proximity to each other in a closed (or operational) position using the locking member 176. In some cases, either one of the fixed member 170 or the moveable member 172 may include one or more protrusions or ridges that may extend at least partially into a corresponding one or more receiving holes or valleys disposed in an opposing surface of the other one of the fixed member 170 or the moveable member 172. The protrusions or ridges mating with corresponding receiving holes or valleys may prevent movement of the proximate surfaces of the fixed member 170 and the moveable member 172 relative to each other when they are in the closed position.

In an example embodiment, the locking member 176 may be configured to be allowed to rotate within a slot 184 defined in the fixed member 170. In some cases, the slot 184 may include a pin 190 extending across the slot 184 and the locking member 176 may include an eye bolt 192 having the pin 190 pass through the eye of the eye bolt 192. Accordingly, the eye bolt 192 may freely rotate around the pin 190. The moveable member 172 may also include a slot 188 that may be disposed to mirror a position of the slot 184 in the fixed member 170 when the fixed member 170 and the moveable member 172 are in the closed position. In an example embodiment, the slots 184 and 188 may be disposed substantially at an opposite side of the fixed member 170 and the moveable member 172, respectively, from the side on which the hinge 174 is disposed.

In an example embodiment, when the fixed member 170 and the moveable member 172 are in the closed position, the eye bolt 192 may be rotated around the pin 190 so that the eye bolt 192 fits into the slot 188 in the moveable member 172. A cap 194 that may be threaded onto the eye bolt 192 may then be tightened to lock the fixed member 170 in proximity to the moveable member 172 as shown in FIGS. 1-3.

When the cap 194 is loosened, the eye bolt 192 may be rotated out of the slot 188 in the moveable member 172. After the eye bolt 192 is rotated out of the slot 188, the moveable member 172 may be free to bend or fold away from the fixed member 170 by rotation at the hinge 174 as shown in FIG. 4. When the moveable member 172 is folded away from the fixed member 170, the moveable member 172 may be said to be in a folded (or non-operational) position. As indicated in FIG. 5, the moveable member 172 may also be rotated back into proximity with the fixed member 170 at any time, and the locking member 176 may be used to lock the fixed member 170 and the moveable member 172 in the closed (or operational) position.

In the example of FIGS. 1-5, the hinge 174 may be oriented toward a front of the riding lawn care vehicle 10 so that when the moveable member 172 is folded away from the fixed member 170, the moveable member 172 extends substantially between the front wheels 32. This arrangement also places the locking member 176 closest to the operator when the operator is positioned at the seat 20. However, the hinge 174 could alternatively be oriented such that the moveable member 172 folds toward the seat 20, or even off to one side or the other in alternative embodiments.

Accordingly, some example embodiments may provide an adjustable steering assembly for employment on a riding lawn care vehicle (e.g., a lawn mower). The adjustable steering assembly may include a vertical adjustment assembly and a folding assembly. The vertical adjustment assembly may be configured to enable telescopic adjustment a height of handles associated with the adjustable steering assembly relative to a rotatable, but vertically fixed portion of the adjustable steering assembly that is operably coupled to at least two wheels of the riding lawn care vehicle. The folding assembly may be configured to enable folding of at least a portion of the adjustable steering assembly. In some embodiments, the vertical adjustment assembly and the folding assembly are configured such that the user may adjust the height of the handle and fold the steering assembly by hand, without the use of tools.

In some example embodiments, the adjustable steering assembly may further include a T-bar steering handle including a handlebar stem. The handlebar stem may telescopically engage at least a portion of the vertical adjustment assembly. In some cases, the vertical adjustment assembly may include a stem receiver. The internal diameter of the stem receiver may be less than an external diameter of the handlebar stem to enable the handlebar stem to slide within the stem receiver to adjust the height of the handles. The stem receiver may include one or more slots disposed at an end of the stem receiver that receives the handlebar stem. The vertical adjustment assembly may also include a locking device (e.g., a locking cam) configured to provide frictional engagement between the stem receiver and the handlebar stem proximate to the one or more slots responsive to locking of the locking device. In some cases, the folding assembly includes a fixed member connected to a portion of the adjustable steering assembly that is coupled to the at least two wheels, and a moveable member that is hingedly attached to the fixed member by a hinge. In an example embodiment, the folding assembly further includes a locking member enabling folding of the adjustable steering assembly when the locking member is released and locking the adjustable steering assembly in an operational configuration when locked. The locking member may rotatably engage a slot disposed at a portion of the moveable member that is disposed at an opposite side of the moveable member than a side of the moveable member on which the hinge is disposed. In some cases, the locking member includes a cap that is threaded to be tightenable to lock the steering assembly in the operational configuration. In an example embodiment, the moveable member folds toward a front end of the riding lawn care vehicle when the folding assembly is enabled to fold.

It should be appreciated that some embodiments of the invention, such as those illustrated herein, are configured such that an operator may be able to adjust the handlebars of a steering assembly relatively easily by hand and without the use of external tools. The adjustment may, in many cases, be made while the operator remains seated on a riding lawn care vehicle employing an example embodiment. In this regard, some embodiments may enable a height of the handlebars to be adjusted for operator comfort, or the handlebars may be folded forward to decrease the profile of the riding lawn care vehicle for storage or shipping. Although the examples described herein illustrate and explain one structural implementation, other example implementations are also possible. For example, other example locking devices may be used in some cases, or the handlebar stem may actually receive a structural member corresponding to the stem receiver and the locking cam may engage the handlebar stem to the structural member. As yet another alternative, the folding assembly may have discrete folded positions to facilitate multiple possible folded positions. For example, one folded position may fold the steering assembly greater than 90 degrees (e.g., as shown in FIG. 4), while other folded positions may correspond to lesser (or greater) degrees of folding in discrete increments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A riding lawn care vehicle comprising:
a frame to which wheels of the riding lawn care vehicle are attachable; and
a steering assembly operably coupled to the frame and configured for steering at least one wheel of the riding lawn care vehicle,
wherein the steering assembly includes:
a vertical adjustment assembly configured to enable telescopic adjustment a height of handles associated with the steering assembly, and
a folding assembly configured to enable folding of at least a portion of the steering assembly.

2. The riding lawn care vehicle of claim 1, wherein the steering assembly further comprises a T-bar steering handle including a handlebar stem, the handlebar stem telescopically engaging at least a portion of the vertical adjustment assembly.

3. The riding lawn care vehicle of claim 2, wherein the vertical adjustment assembly includes a stem receiver, and wherein an internal diameter of the stem receiver is less than an external diameter of the handlebar stem to enable the handlebar stem to slide within the stem receiver to adjust the height of the handles.

4. The riding lawn care vehicle of claim 3, wherein the vertical adjustment assembly includes a locking cam configured to provide frictional engagement between the stem receiver and the handlebar stem responsive to locking of the locking cam.

5. The riding lawn care vehicle of claim 3, wherein the stem receiver includes one or more slots disposed at an end of the stem receiver that receives the handlebar stem, and wherein the vertical adjustment assembly includes a locking device configured to provide frictional engagement between the stem receiver and the handlebar stem proximate to the one or more slots responsive to locking of the locking device.

6. The riding lawn care vehicle of claim 5, wherein the vertical adjustment assembly further includes a bracket disposed to maintain a position of the locking device proximate to the one or more slots.

7. The riding lawn care vehicle of claim 1, wherein the folding assembly includes a fixed member connected to a portion of the steering assembly that is coupled to the wheels, and a moveable member that is hingedly attached to the fixed member by a hinge.

8. The riding lawn care vehicle of claim 7, wherein the folding assembly further includes a locking member enabling folding of the steering assembly when the locking member is released and locking the steering assembly in an operational configuration when locked.

9. The riding lawn care vehicle of claim 8, wherein the locking member rotatably engages a slot disposed at a portion of the moveable member that is disposed at an opposite side of the moveable member than a side of the moveable member on which the hinge is disposed.

10. The riding lawn care vehicle of claim 9, wherein the locking member includes a cap that is threaded to be tightenable to lock the steering assembly in the operational configuration.

11. The riding lawn care vehicle of claim 7, wherein the moveable member folds toward a front end of the riding lawn care vehicle when the folding assembly is enabled to fold.

12. The riding lawn care vehicle of claim 1, wherein the riding lawn care vehicle is a riding lawn mower.

13. The riding lawn care vehicle of claim 1, further comprising a vertically adjustable seat, wherein the steering assembly is adjustable such that the steering assembly is disposable at or entirely below a height of a lowered seat back position of the vertically adjustable seat for shipping or storage.

14. An adjustable steering assembly for employment on a riding lawn care vehicle, the adjustable steering assembly comprising:
a vertical adjustment assembly configured to enable telescopic adjustment a height of handles associated with the adjustable steering assembly relative to a rotatable, but vertically fixed portion of the adjustable steering assembly that is operably coupled to at least one wheel of the riding lawn care vehicle, and
a folding assembly configured to enable folding of the vertical adjustment assembly relative to an operational position of the adjustable steering assembly.

15. The adjustable steering assembly of claim 14, further comprising a T-bar steering handle including a handlebar stem, the handlebar stem telescopically engaging at least a portion of the vertical adjustment assembly.

16. The adjustable steering assembly of claim 15, wherein the vertical adjustment assembly includes a stem receiver, and wherein an internal diameter of the stem receiver is less than an external diameter of the handlebar stem to enable the handlebar stem to slide within the stem receiver to adjust the height of the handles.

17. The adjustable steering assembly of claim 16, wherein the vertical adjustment assembly includes a locking cam configured to provide frictional engagement between the stem receiver and the handlebar stem responsive to locking of the locking cam.

18. The adjustable steering assembly of claim 16, wherein the stem receiver includes one or more slots disposed at an end of the stem receiver that receives the handlebar stem, and wherein the vertical adjustment assembly includes a locking device configured to provide frictional engagement between the stem receiver and the handlebar stem proximate to the one or more slots responsive to locking of the locking device.

19. The adjustable steering assembly of claim 18, wherein the vertical adjustment assembly further includes a bracket disposed to maintain a position of the locking device proximate to the one or more slots.

20. The adjustable steering assembly of claim 14, wherein the folding assembly includes a fixed member connected to a portion of the adjustable steering assembly that is coupled to the at least one wheel, and a moveable member that is hingedly attached to the fixed member by a hinge.

21. The adjustable steering assembly of claim 20, wherein the folding assembly further includes a locking member enabling folding of the adjustable steering assembly when the locking member is released and locking the adjustable steering assembly in an operational configuration when locked.

22. The adjustable steering assembly of claim 21, wherein the locking member rotatably engages a slot disposed at a portion of the moveable member that is disposed at an opposite side of the moveable member than a side of the moveable member on which the hinge is disposed.

23. The adjustable steering assembly of claim 22, wherein the locking member includes a cap that is threaded to be tightenable to lock the steering assembly in the operational configuration.

24. The adjustable steering assembly of claim 20, wherein the moveable member folds toward a front end of the riding lawn care vehicle when the folding assembly is enabled to fold.
